(19) United States
(12) Patent Application Publication
(10) Pub. No.: US 2023/0311514 A1
(43) Pub. Date: Oct. 5, 2023

(54) LIQUID DISCHARGING APPARATUS

(71) Applicant: BROTHER KOGYO KABUSHIKI KAISHA, Nagoya (JP)

(72) Inventors: Fumiya NAKAMURA, Nagoya (JP); Shohei ICHIKAWA, Niwa (JP); Kazushige SAIGUSA, Nagoya (JP); Kazuma KOBAYASHI, Nagoya (JP); Asami HASHIMOTO, Okazaki (JP); Masako KAWAGOE, Nagoya (JP); Haruhisa SHIRAI, Kasugai (JP)

(73) Assignee: BROTHER KOGYO KABUSHIKI KAISHA, Nagoya (JP)

(21) Appl. No.: 18/192,969

(22) Filed: Mar. 30, 2023

(30) Foreign Application Priority Data
Apr. 1, 2022 (JP) 2022-062147

(51) Int. Cl. B41J 2/165

(52) U.S. Cl. CPC B41J 2/16517

(57) ABSTRACT

A liquid discharging apparatus, having a sheet conveyer path, a liquid discharging head including nozzles for discharging liquid, a maintenance unit configured to remove the liquid from discharging head, a waste liquid tank demountably mounted in a housing of the liquid discharging apparatus and configured to store the liquid received from the maintenance unit, and a waste liquid flow path for transporting the liquid from the maintenance unit to the waste liquid tank, is provided. The waste liquid tank is located opposite to the maintenance unit across the sheet conveyer path in a horizontal direction, which is parallel to a nozzle surface of the liquid discharging head.

### REFERENCE TO RELATED APPLICATIONS

This application claims priority from Japanese Patent Application No. 2022-062147 filed on Apr. 1, 2022. The entire content of the priority application is incorporated herein by reference.

### BACKGROUND ART

A liquid discharging apparatus having a waste liquid container is known. The waste liquid container may be detachably attached to a housing of the liquid discharging apparatus.

### DESCRIPTION

The liquid discharging apparatus may have an attachment section, in which the waste liquid container may be demountably mounted, and a disposal section, to which waste liquid discharged from a maintenance unit may be guided. The disposal section may be located above the attachment section. In this arrangement, in which the waste liquid container is arranged on a same side of the housing of the liquid discharging apparatus as the maintenance section, a space inside the liquid discharging apparatus may not be efficiently used.

The present disclosure is advantageous in that a liquid discharging apparatus, in which an inner space may be efficiently used, is provided.

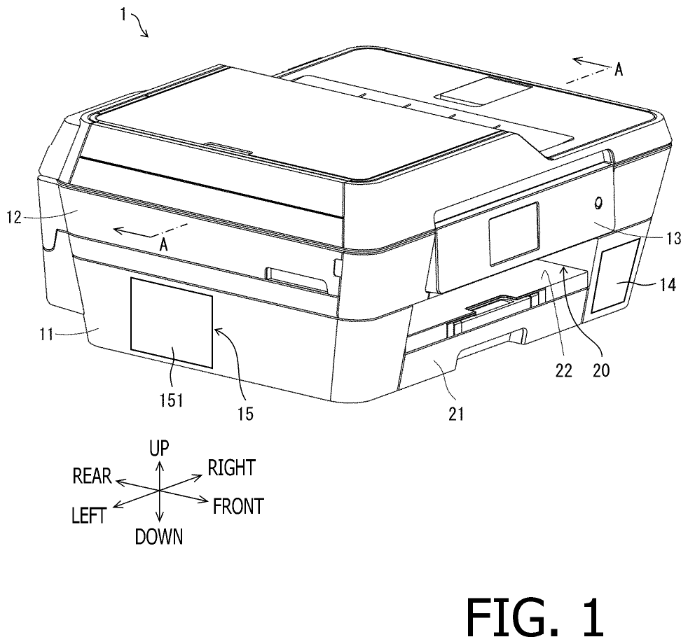

FIG. 1 is a perspective exterior view of an inkjet printer.

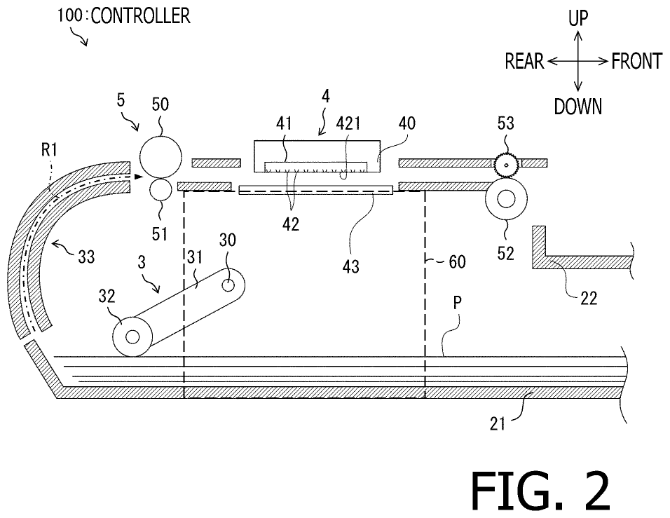

FIG. 2 is a cross-sectional view to illustrate an inner structure of the inkjet printer.

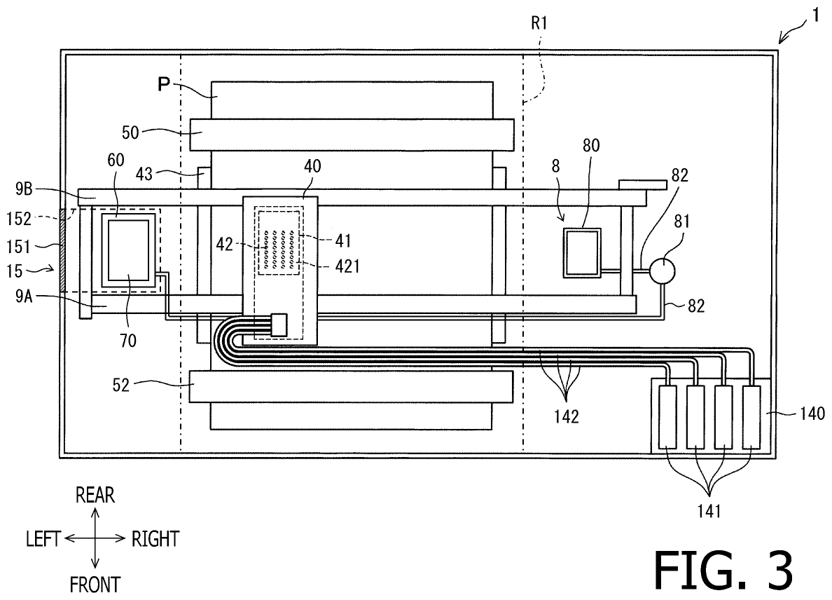

FIG. 3 is a cross-sectional view of the inkjet printer from an upper side.

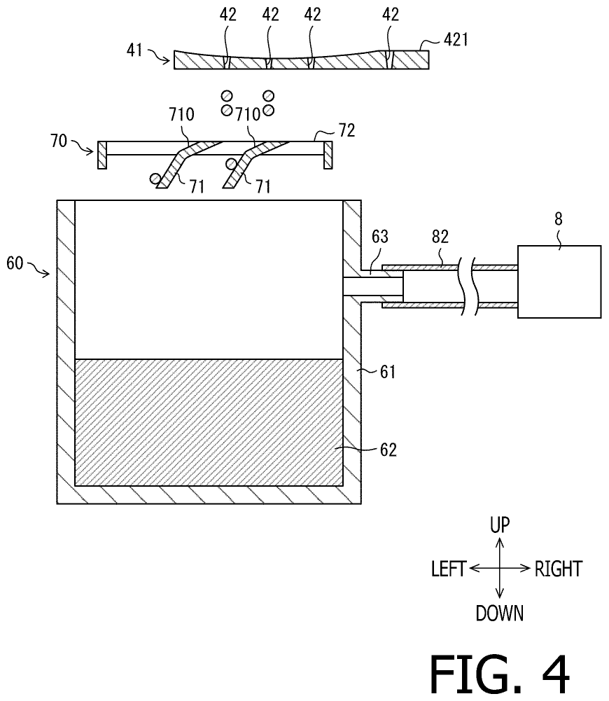

FIG. 4 is a cross-sectional view of a waste liquid tank and a flushing unit.

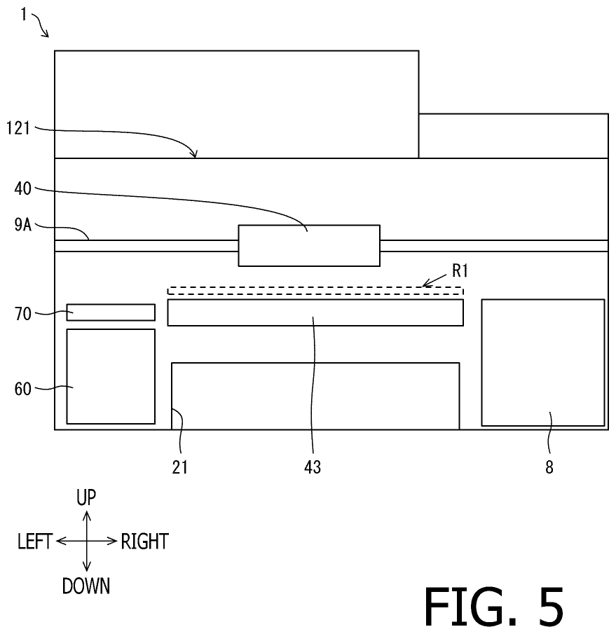

FIG. 5 is a cross-sectional view of the inkjet printer sectioned at line A-A shown in FIG. 1.

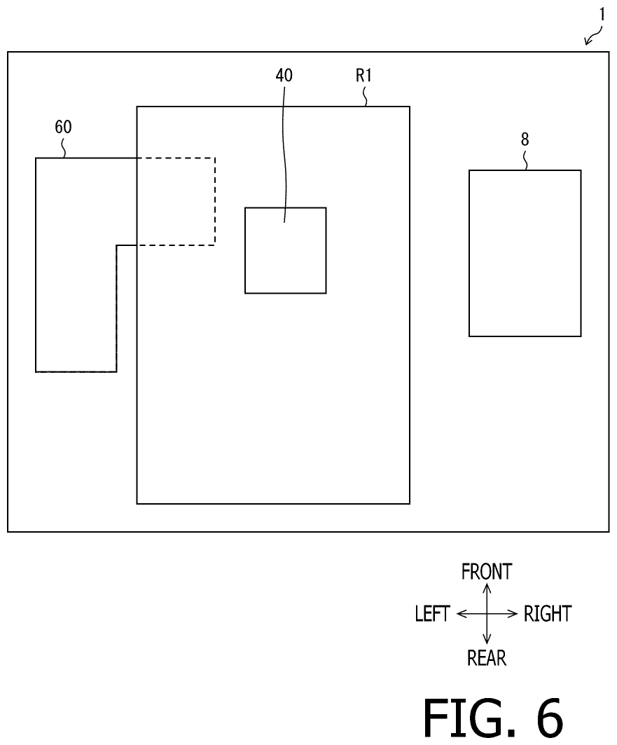

FIG. 6 is a top plan view to illustrate arrangement of a maintenance unit, a conveyer path, and the waste liquid tank.

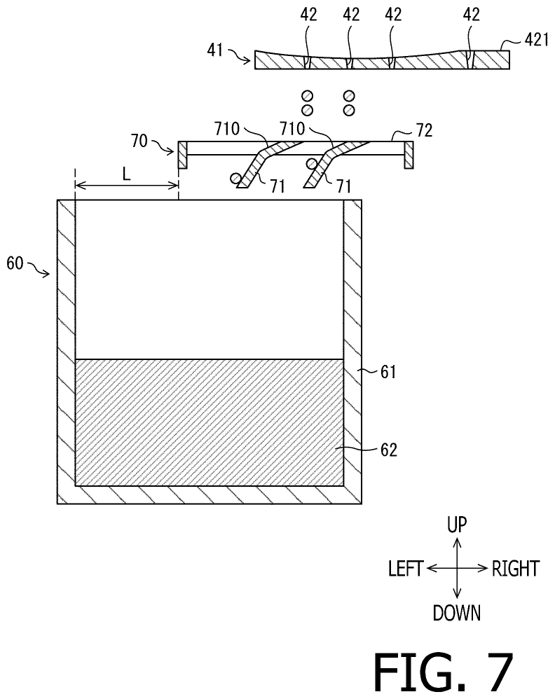

FIG. 7 illustrates an arrangement of a waste liquid guide and the waste liquid tank.

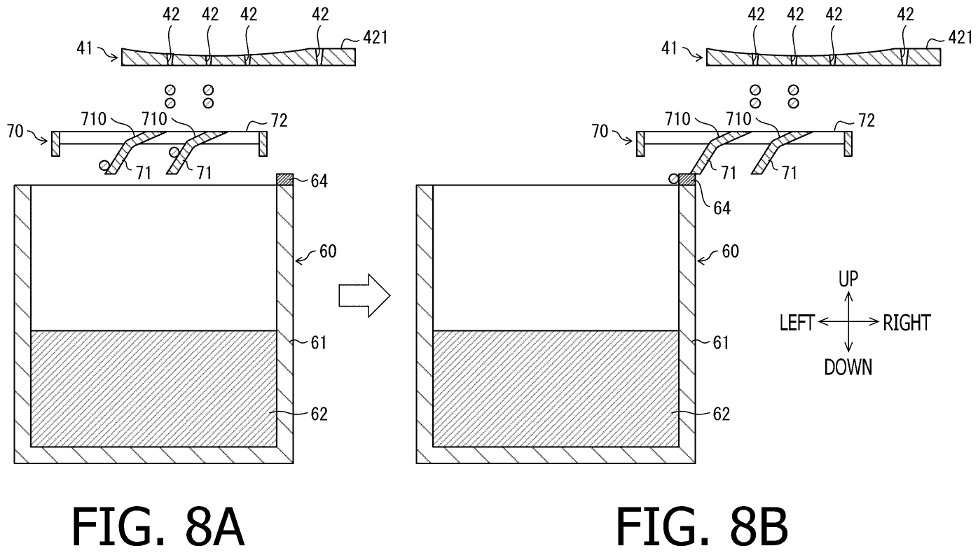

FIG. 8A illustrates a waste liquid tank mounted in a main housing. FIG. 8B illustrates the waste liquid tank drawn outward from the main housing.

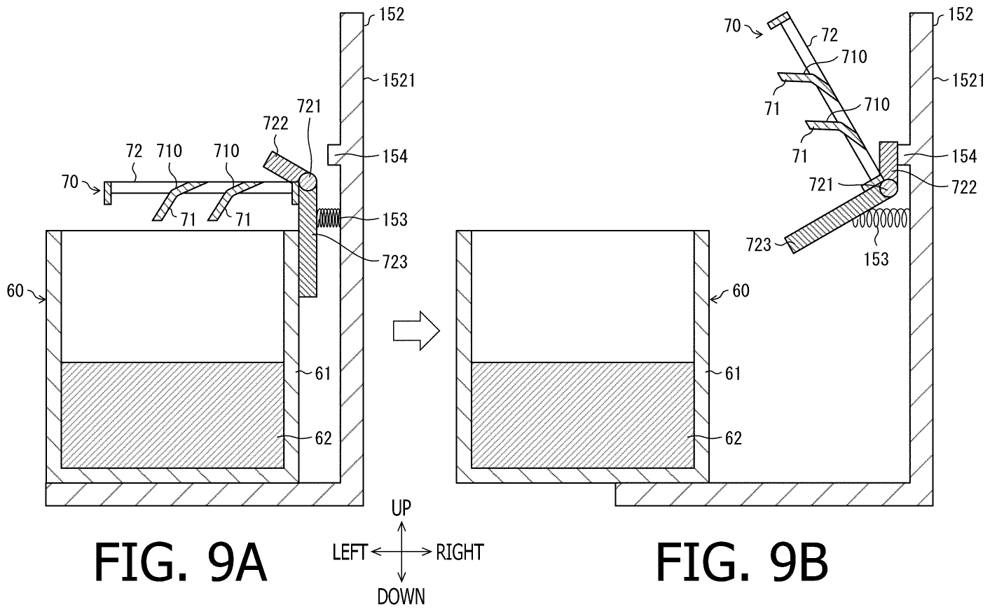

FIG. 9A illustrates a waste liquid tank mounted in a compartment. FIG. 9B illustrates the waste liquid tank drawn outward from the compartment.

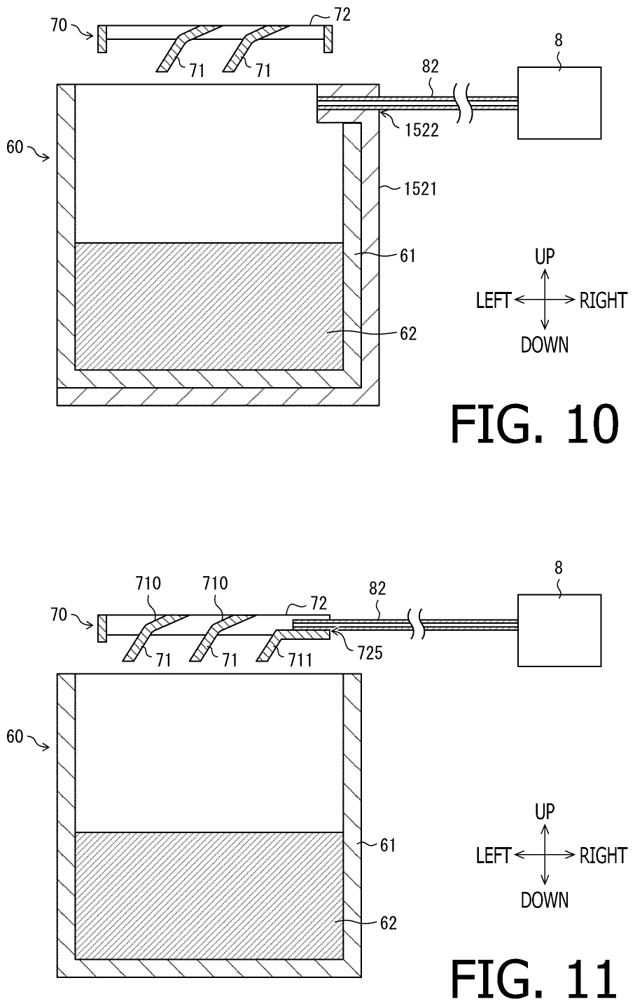

FIG. 10 is an illustrative view of a compartment.

FIG. 11 is an illustrative view of a flushing unit.

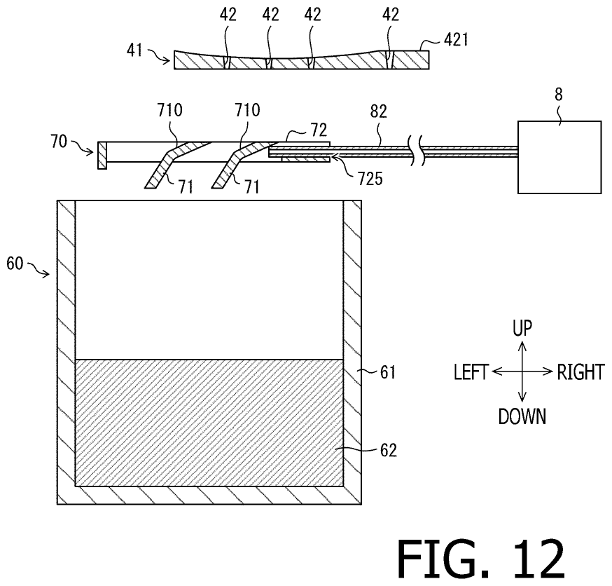

FIG. 12 is an illustrative view of a flushing unit.

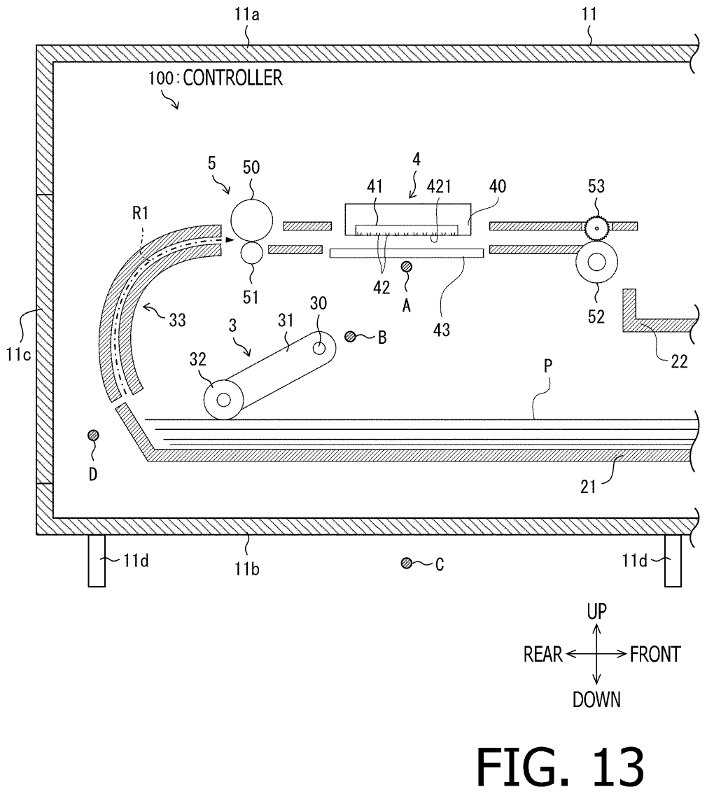

FIG. 13 is a cross-sectional view of the inkjet printer indicating positions A-D of a tube.

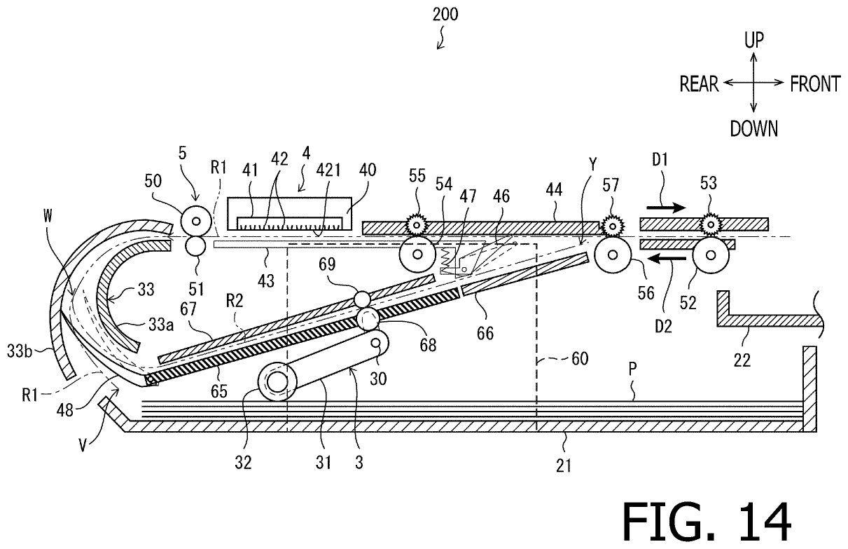

FIG. 14 is a cross-sectional view to illustrate an inner structure of an inkjet printer.

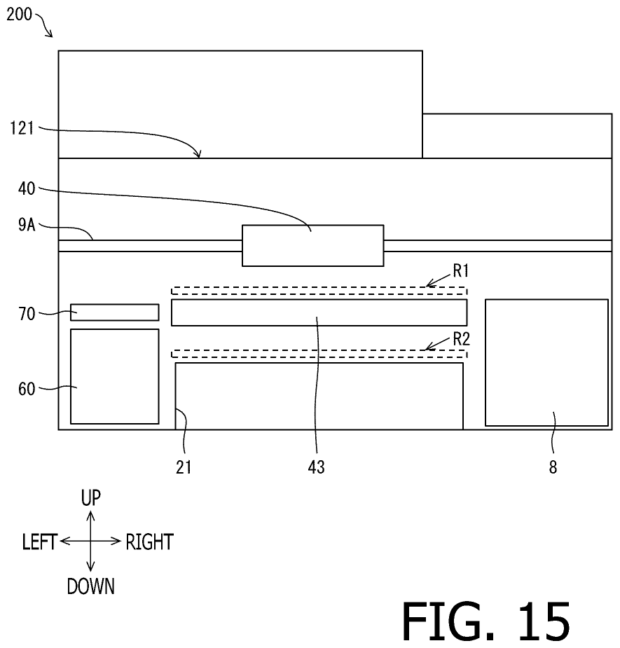

FIG. 15 is a cross-sectional view of the inkjet printer viewed from front.

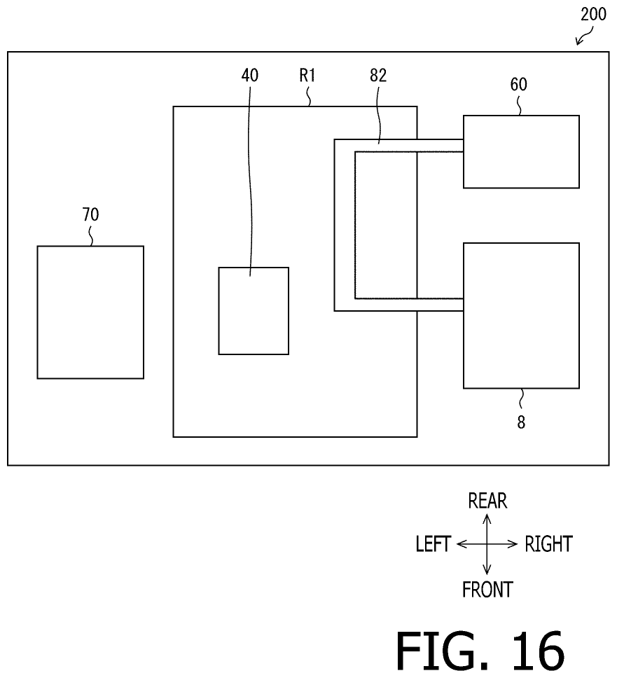

FIG. 16 is a cross-sectional view of an inkjet printer viewed from an upper side.

### FIRST EMBODIMENT

<Overall Configuration of Inkjet Printer>

An overall configuration of an inkjet printer 1 will be described below with reference to FIGS. 1-3. FIG. 1 is a perspective exterior view of the inkjet printer 1. FIG. 2 is a cross-sectional view to illustrate an inner structure of the inkjet printer 1. FIG. 3 is a cross-sectional view of the inkjet printer 1 viewed from an upper side.

The inkjet printer 1 shown in FIG. 1 may discharge liquid. In the following description, directions in the inkjet printer 1 are defined with reference to an orientation of the inkjet printer 1 in a usable condition set on a base plane as shown in FIG. 1: a vertical direction as indicated by upward and downward arrows in FIG. 1 includes up-to-down and down-to-up directions, whereas a side toward the base plane is defined as a lower side. A front-rear direction as indicated by arrows pointing lower-rightward and upper-rearward in FIG. 1 includes front-to-rear and rear-to-front directions, whereas a side on which an opening 20 is located is defined as a front side. A left-right direction, or a widthwise direction, as indicated by arrows pointing lower-leftward and upper-rightward in FIG. 1 includes leftward and rightward directions, whereas a lefthand side to a user who faces a face on the front side of the inkjet printer 1 is defined as a leftward side. The widthwise direction may also be called a scanning direction, in which a carriage 40 (see FIG. 2) is movable. The carriage 40 will be described further below.

As shown in FIG. 1, the inkjet printer 1 includes a main housing 11 and a scanner housing 12 stacked on an upper side in the inkjet printer 1. The main housing 11 and the scanner housing 12 together form a substantially rectangular boxed shape.

On a front side of the main housing 11, an operation panel 13, a cartridge cover 14, and a tank exchangeable unit 15 are arranged. The operation panel 13 includes operation devices, such as operation buttons, and a liquid crystal display. The cartridge cover 14 is pivotable with respect to the main housing 11. Inside the cartridge cover 14, as shown in FIG. 3, ink cartridges 141 are arranged and attached to a cartridge case 140. Moreover, as shown in FIG. 1, on the front side of the main housing 11, the opening 20 is formed. Through the opening 20 formed on the front side of the main housing 11, a feeder tray 21 and an ejection tray 22 may be attached to or detached from the inkjet printer 1. The scanner housing 12 accommodates a scanner 121 (see FIG. 5), which may read an image appearing on a sheet P.

The tank exchangeable unit 15 is located on a sideward face on a widthwise end of the main housing 11. For example, the tank exchangeable unit 15 may be located on a leftward face of the main housing 11. The tank exchangeable unit 15 includes a cover 151, which is pivotable with respect to the main housing 11, and a compartment 152 (see FIG. 3), which is exposed when the cover 151 is open and may accommodate a waste liquid tank 60. In other words, the cover 151 being open allows the waste liquid tank 60 to be mounted in and demounted from the main housing 11.

The compartment 152 may have a form to fit with the waste liquid tank 60. The compartment 152 has a wall, on which a sideward face of the waste liquid tank 60 may abut, on an inner side in a mounting/demounting direction of the waste liquid tank 60. The wall may therefore restrict the waste liquid tank 60 from moving further inward.

The tank exchangeable unit 15 may not necessarily have the cover 151 being openable/closable. For example, a waste liquid tank unit, which consists of the waste liquid tank 60 and a tank retainer having the cover 151 to retain the waste liquid tank 60, may be mounted in and demounted from the main housing 11. In this arrangement, when the waste liquid tank unit is demounted from the main housing 11, an opening having a form that corresponds to a form of the waste liquid tank unit may be exposed; and when the waste liquid tank unit is mounted in the main housing 11, the cover 151 attached to the waste liquid tank unit may close the opening. Moreover, the tank exchangeable unit 15 may not necessarily be located on the side on the widthwise end of the main housing 11 but may be located on a side of the main housing 11 in the front-rear direction or in the vertical direction. In the following paragraphs, the direction, in which the waste liquid tank 60 may be mounted in or demounted from the main housing 11 may be called a mounting/demounting direction.

<Internal Configuration of Inkjet Printer 1>

Next, an internal configuration of the inkjet printer 1 will be described with reference to FIG. 2.

As shown in FIG. 2, the inkjet printer 1 includes a feeder 3, a recorder 4, a conveyer 5, and a controller 100.

The feeder 3 includes a shaft 30, a feeder arm 31, and a feeder roller 32. The feeder 3 may feed sheets P stored in the feeder tray 21 to a conveyer path R1 by rotating the feeder roller 32. The feeder roller 32 is located at a tip end of the feeder arm 31 and is supported rotatably by the feeder arm 31. The feeder arm 31 is pivotably supported by the shaft 30, which is supported by a frame of the inkjet printer 1. The feeder arm 31 is urged toward the feeder tray 21 by weight thereof or by an urging force from, for example, a spring.

The conveyer path R1 extends upward from a rear end of the feeder tray 21, curving frontward in an area delimited by a guide member 33, to the ejection tray 22.

The feeder roller 32 may, when a feeder motor (not shown) is activated by the controller 100, pick up the sheets P from the feeder tray 21 one by one. The sheets P picked up from the feeder tray 21 may be conveyed along the conveyer path R1 and fed to the recorder 4.

The recorder 4 is located above the feeder 3. The recorder 4 includes a carriage 40, a recording head 41 for discharging liquid, a plurality of nozzles 42, and a platen 43. The carriage 40 is supported by guide rail 9A and a guide rail 9B, which extend in the widthwise direction. The carriage 40 may, when a driving force from a carriage motor (not shown) is transmitted thereto, move back and forth in the scanning direction which is the widthwise direction, i.e., a direction of width of the sheet P being conveyed. For recording an image on the sheet P, the controller 100 of the inkjet printer 1 may repeat a recording process, in which the controller 100 operates the carriage 40 to move in the widthwise direction and the recording head 41 to discharge ink through the nozzles 42 while the sheet P stays still, and a conveying process, in which the controller 100 drives a conveyer roller 50 and an ejection roller 52 to convey the sheet P by a predetermined linefeed amount, alternately.

On the carriage 40, the recording head 41 is mounted. The plurality of nozzles 42 are formed on a lower face of the recording head 41. The plurality of nozzles 42 are arrayed in lines along the front-rear direction to form nozzle lines, and four (4) nozzle lines are formed on a nozzle surface 421 to align in the widthwise direction. The nozzles 42 forming a first one of the nozzle lines, a second one of the nozzle lines, a third one of the nozzle lines, and a fourth one of the nozzle lines from right to left, may discharge inks in colors of black, yellow, cyan, and magenta, respectively. However, the aligning order of the nozzle lines may not necessarily be limited but may be changed optionally.

The recording head 41 may discharge ink droplets through the nozzles 42 by causing vibrating elements such as piezo elements to vibrate.

The platen 43 is located below the recording head 41 and extends throughout or over the entire length of the sheet P in the widthwise direction. The platen 43 may support the sheet P from below during the recording process. While the carriage 40 moves in the widthwise direction over the sheet P supported by the platen 43, the recording head 41 may discharge the ink droplets selectively from the nozzles 42 to record the image on the sheet P.

The conveyer 5 includes the conveyer roller 50 and the ejection roller 52, which are located on one side and the other side, respectively, of the carriage 40 and the platen 43 in the front-rear direction. At a position below the conveyer roller 50, a pinch roller 51 is arranged to face the conveyer roller 50. The conveyer roller 50 may be driven by a conveyer motor (not shown) to rotate. The pinch roller 51 may rotate along with the rotation of the conveyer roller 50. With the rotation of the conveyer roller 50 and the pinch roller 51, the sheet P nipped between the conveyer roller 50 and the pinch roller 51 may be conveyed along the conveyer path R1 to the recorder 4.

The ejection roller 52 is located on a downstream side of the conveyer roller 50 across the carriage 40 and the platen 43 in a conveying direction to convey the sheet P from the feeder tray 21 to the ejection tray 22. At a position above the ejection roller 52, a spur roller 53 is arranged to face the ejection roller 52. The ejection roller 52 may be driven by the conveyer motor (not shown) to rotate. The spur roller 53 may rotate along with the rotation of the ejection roller 52. With the rotation of the ejection roller 52 and the spur roller 53, the sheet P nipped between the ejection roller 52 and the spur roller 53 may be ejected from the conveyer path R1 to rest at the ejection tray 22.

The controller 100 includes a Central Processing Unit (CPU), a Read-Only Memory (ROM), a Random Access Memory (RAM), and Application Specific Integrated Circuit (ASIC) including a variety of controlling circuits. The controller 100 is connected with devices that compose the inkjet printer 1, including the recording head 41 and the conveyer motor of the conveyer 5. The controller 100 is, moreover, connected with the operation panel 13 and external devices such as a PC (not shown).

The controller 100 may run programs stored in the ROM to cause the CPU and the ASIC to execute processes to control acts of the devices, including the recording head 41 and a maintenance unit 8, such as a flushing action to discharge ink droplets from the nozzles 42. The controller 100 may control the recording head 41 and the conveyer motor according to a printing command transmitted from the external device such as the PC and execute a printing process to print the image on the sheet P. The maintenance unit 8 and the flushing action will be described further below. It may be noted that the controller 100 may not necessarily consist of the CPU, the ROM, the RAM, and the ASIC alone but may consist of any hardware devices.

The inkjet printer 1 in the configuration as described above may operate the conveyer 5 to convey the sheet P in the conveying direction, move the carriage 40 along with the recording head 41 in the scanning direction, and operate the recording head 41 to discharge the ink to print an image on the sheet P.

<Cartridge Case 140>

Next, the cartridge case 140 will be described with reference to FIG. 3. As shown in FIG. 3, the cartridge case 140 may contain four (4) ink cartridges 141 aligning in the widthwise direction. The ink cartridges 141 are removable from the cartridge case 140 and may contain inks in the colors of black, yellow, cyan, and magenta. The inks contained in the ink cartridges 141 may be supplied to the recording head 41 through tubes 142.

<Maintenance Unit 8>

Next, the maintenance unit 8 will be described with reference to FIG. 3. As shown in FIG. 3, the inkjet printer 1 has the maintenance unit 8. The maintenance unit 8 includes a cap 80, a pump 81, and a tube 82. The maintenance unit 8 is located at a position lower than a scanning path of the carriage 40 and on an outer side from the platen 43 in the scanning direction. In the present embodiment, the maintenance unit 8 is located rightward with respect to the platen 43. However, the maintenance unit 8 may optionally be located leftward with respect to the platen 43. When the maintenance unit 8 is located leftward with respect to the platen 43, a waste liquid tank 60 and a flushing unit 70 may be located rightward with respect to the platen 43.

The cap 80 is formed of rubber. The cap 80 is located at a position lower than the recording head 41 and outward from the platen 43 in the scanning direction. When the carriage 40 is located at a maintenance position, which is on an outer side from the platen 43 in the scanning direction, the cap 80 faces the nozzle surface 421 of the recording head 41.

The cap 80 is movable in the vertical direction by, for example, a lifting device (not shown). The cap 80 located at the maintenance position may move upward to fit with the nozzle surface 421.

The pump 81 may be driven by a motor (not shown) to suction the inks in the nozzles 42 through the cap 80 and the tube 82 and eject the suctioned inks through the tube 82 at the waste liquid tank 60.

The tube 82 forms a flow path, in which the inks ejected from the maintenance unit 8 may be transported to the waste liquid tank 60. The tube 82 is made of a flexible material. The inks may be transported from the cap 80 through the pump 81 to the waste liquid tank 60.

The maintenance unit 8 in the configuration as described above may perform maintenance acts on the recording head 41. In particular, the maintenance unit 8 may perform a purging action to suction the inks and the air in the nozzles 42 and dust adhered to the nozzles 42 as a maintenance act. In the following paragraphs, the term “inks” may include the inks and the air in the nozzles 42 and the dust adhered to the nozzles 42. Thus, the maintenance unit 8 may remove the inks from the nozzles 42 by suctioning with the pump 81. The inks removed from the recording head 41 by the maintenance unit 8 may be stored in the waste liquid tank 60.

<Waste Liquid Tank 60>

Next, the waste liquid tank 60 will be described with reference to FIGS. 3-4. FIG. 4 is a cross-sectional view of the waste liquid tank 60 and the flushing unit 70. The flushing unit 70 will be described later.

As shown in FIG. 3, the inkjet printer 1 has the waste liquid tank 60. The waste liquid tank 60 has, as shown in FIG. 4, a waste liquid case 61, an ink absorber foam 62, and a port 63.

The waste liquid case 61 may be made of, for example, synthetic resin. The waste liquid case 61 has an opening at an upper side thereof and has a substantially rectangular boxed shape in a top plan view. In other words, the waste liquid case 61 has a bottom surface and side surfaces rising upright from edges of the bottom surface. The ink absorber foam 62 is arranged inside the waste liquid case 61.

The ink absorber foam 62 may be made of, for example, unwoven fabric, sponge, or cotton that may absorb the inks. The ink absorber foam 62 is arranged inside the waste liquid case 61.

The port 63 connects the waste liquid case 61 to the tube 82. The port 63 is formed of a part of the waste liquid case 61 protruding rightward from the rightward side surface of the waste liquid case 61. The port 63 forms a communication channel to connect the inside and the outside of the waste liquid case 61. The port 63 is in a form, to which the tube 82 is connectable. The tube 82 connected to the port 63 therefore connects the waste liquid tank 60 and the maintenance unit 8, and the inks ejected from the maintenance unit 8 may be stored in the waste liquid tank 60. It may be noted that the port 63 may not necessarily be located on the rightward side surface of the waste liquid case 61 but may optionally be located on, for example, a frontward side surface, or a leftward side surface, as long as the port 63 is located on any one of the side surfaces of the waste liquid case 61.

<Flushing Unit 70>

The flushing unit 70 has, as shown in FIG. 4, the waste liquid guide 71 and a guide retainer frame 72, to which the waste liquid guide 71 is fixed. The flushing unit 70 may prevent the inks discharged from the nozzles 42 from scattering in mist during a flushing process and guide the inks to the waste liquid tank 60. The waste liquid guide 71 may include one or more pieces of waste liquid guide 71.

The flushing process is an action to operate the recording head 41 while the carriage 40 is located at a flushing position, where the carriage 40 faces the flushing unit 70, to discharge the inks through the nozzles 42 at the waste liquid guide 71, rather than at the sheet P.

For preventing the inks discharged in the flushing process from scattering in mist, the waste liquid guide 71 has a slant surface 710 extending in a direction to intersect with the vertical direction, which is a direction to discharge the inks from the nozzles 42. For example, the slant surface 710 may slant uphill toward the right.

The inks discharged from the recording head 41 in the flushing process may land on the slant surface 710 of the waste liquid guide 71 and may be guided along the slant surface 710 to the ink absorber foam 62 located inside the waste liquid tank 60.

The guide retainer frame 72 retains the waste liquid guide 71. The guide retainer frame 72 is a frame, to which the waste liquid guide 71 is fixed, and has a substantially rectangular form in a top plan view. The guide retainer frame 72 may be fixed to the main housing 11 by, for example, being fastened with screws.

<Arrangement of Waste Liquid Tank 60 and Flushing Unit 70>

Arrangement of the waste liquid tank 60 and the flushing unit 70 will be described with reference to FIGS. 3-6. FIG. 5 is a cross-sectional view of the inkjet printer 1 sectioned at line A-A shown in FIG. 1. FIG. 6 is a top plan view to illustrate arrangement of the maintenance unit 8, the conveyer path R1, and the waste liquid tank 60.

The waste liquid tank 60 and the flushing unit 70 are, as shown in FIGS. 3-6, located at positions lower than the scanner 121. In particular, the waste liquid tank 60 and the flushing unit 70 are located at positions lower than the recording head 41 and on the outer side from the platen 43 in the scanning direction.

In other words, as shown in FIG. 3, the waste liquid tank 60 and the flushing unit 70 are located on one side of the conveyer path R1 opposite to the maintenance unit 8 in a horizontal direction, which is parallel to the nozzle surface 421, i.e., in the widthwise direction. Moreover, as shown in FIG. 4, in the vertical direction, the waste liquid tank 60 is located to be lower than the flushing unit 70. In this arrangement, the positions of the waste liquid tank 60, the conveyer path R1, and the maintenance unit 8 are, in a view from a frontward position with respect to the inkjet printer 1, as shown in FIG. 5, in an arrangement such that the maintenance unit 8, the conveyer path R1, and the waste liquid tank 60 are arrayed side by side in the widthwise direction from right to left in this recited order. However, as long as the maintenance unit 8, the conveyer path R1, and the waste liquid tank 60 are arrayed side by side in the widthwise direction, the maintenance unit 8, the conveyer path R1, and the waste liquid tank 60 may not necessarily align at a same height in the vertical direction. In other words, for example, the maintenance unit 8 may be located to be lower than the conveyer path R1 while the waste liquid tank 60 may be located to be higher than the conveyer path R1 in the inkjet printer 1.

Optionally, as shown in FIG. 6, the waste liquid tank 60 may be located at a position to at least partly overlap the conveyer path R1 in the direction intersecting orthogonally with the nozzle surface 421. More specifically, the waste liquid tank 60 may be located at a position where a part of the waste liquid tank 60 is located to be lower than the conveyer path R1 to overlap the conveyer path R1 in the vertical direction. In this arrangement of the waste liquid tank 60, a space below the conveyer path R1 may be efficiently used. In other words, dimensions of the waste liquid tank 60 may be enlarged not only in the front-rear direction of the main housing 11 but also in the widthwise direction. For example, the waste liquid tank 6 may be formed in a shape of L in a top plan view as shown in FIG. 6. Accordingly, a capacity of the waste liquid tank 60 to store the waste liquid may increase while the space inside the inkjet printer 1 may be efficiently used.

In the present embodiment, while the maintenance unit 8 is located on the rightward side of the conveyer path R1, the waste liquid tank 60 and the flushing unit 70 are located on the leftward side opposite to the maintenance unit 8 across the conveyer path R1. However, the arrangement of the waste liquid tank 60 and the flushing unit 70 may not necessarily be limited as long as the waste liquid tank 60 and the flushing unit 70 are located on one side of the conveyer path R1 and the maintenance unit 8 is located on the other side of the conveyer path R1. In the arrangement of the waste liquid tank 60 and the maintenance unit 8 located on the opposite sides across the conveyer path R1, the tube 82 traverses the conveyer path R1 to connect the waste liquid tank 60 and the maintenance unit 8, as shown in FIG. 3.

To describe the arrangement of the tube 82 in the main housing 11 more specifically, the tube 82 is located rearward with respect to the operation panel 13. Therefore, compared to an arrangement, in which the tube 82 is located outward from the operation panel 13, a length of the tube 82 may be reduced. Moreover, the tube 82 is located to be lower than the scanner 121. Therefore, compared to an arrangement, in which the tube 82 is extended through the scanner 121, the length of the tube 82 may be reduced. Further, the tube 82 is located frontward with respect to the recording head 41. Moreover, the tube 82 is located to be higher than the conveyer path R1. Therefore, the length of the tube 82 may be reduced and the tube 82 may be exchanged easily with a new tube 82. In the meantime, optionally, the tube 82 may be located rearward with respect to the recording head 41.

Meanwhile, the waste liquid tank 60 is, as shown in FIG. 5, arrayed sideward to the feeder tray 21 and the platen 43 in the widthwise direction. In particular, as shown in FIG. 2, the waste liquid tank 60 is located at a position to at least partly overlap the feeder tray 21 and the platen 43 in a sideward view along the widthwise direction, which is parallel to the nozzle surface 421 and intersects orthogonally with the conveying direction to convey the sheets P.

Moreover, the waste liquid tank 60 is located at a position, at which the waste liquid tank 60 overlaps the nozzle surface 421 of the recording head 41 at least partly in the vertical direction, i.e., in the direction intersecting orthogonally with the nozzle surface 421 of the recording head 41. For example, in the condition where the carriage 40 is located at the flushing position, solely one of the four nozzle lines aligning in the widthwise direction on the nozzle surface 421 may be located to overlap the waste liquid tank 60 in the vertical direction. For another example, in the condition where the carriage 40 is located at the flushing position, the entire four nozzle lines aligning in the widthwise direction on the nozzle surface 421 may be located to overlap the waste liquid tank 60 in the vertical direction.

Optionally, the flushing unit 70 may not be located above the waste liquid tank 60 but may be omitted.

<Benefits>

According to the configuration described above, the waste liquid tank 60 is mounted in the main housing 11 at the position opposite to the maintenance unit 8 across the conveyer path R1 in the horizontal direction, which is parallel to the nozzle surface 421 of the recording head 41. Therefore, the space on the side of the conveyer path R1 opposite to the maintenance unit 8 may be used to locate the waste liquid tank 60. Accordingly, the space inside the inkjet printer 1 may be used more efficiently compared to the conventional arrangement.

According to the configuration described above, moreover, the waste liquid tank 60 may be located at the position to at least partly overlap the nozzle surface 421 in the direction intersecting orthogonally with the nozzle surface 421. Therefore, for example, when the flushing process to remove the liquid from the nozzles 42 is performed, the waste liquid produced in the flushing process may be collected in the waste liquid tank 60. In other words, the waste liquid produced in the maintenance process and the waste liquid produced in the flushing process may be collected in the same waste liquid tank 60, and a separate tank to collect the waste liquid produced in the flushing process is not necessary. Accordingly, while manufacturing cost may be reduced, the space inside the inkjet printer 1 may be used more efficiently compared to the conventional arrangement.

According to the configuration described above, moreover, inside the inkjet printer 1, in which the waste liquid tank 60 is located opposite to the maintenance unit 8 across the conveyer path R1, the tube 82 may be shortened compared to an arrangement, in which, for example, the tube 82 is arranged not to traverse the conveyer path R1 but to detour around the conveyer path R1. In other words, if the tube 82 is arranged not to traverse the conveyer path R1, the tube 82 may be extended to detour around the conveyer path R1 on either the front side or the rear side of the conveyer path R1. In this regard, by arranging the tube 82 to traverse the conveyer path R1, the tube 82 may be shortened and may be arranged more easily in the main housing 11.

According to the configuration described above, moreover, the waste liquid tank 60 and the feeder tray 21 are arrayed side by side in the horizontal direction in a view from the side of the nozzle surface 421, e.g., in a view from the upper side. In this arrangement, for example, compared to an arrangement, in which the waste liquid tank 60 overlaps the feeder tray 21 in the vertical direction, the dimension in the vertical direction may be reduced. Accordingly, the space by the feeder tray 21 may be used efficiently, and the height of the inkjet printer 1 may be restrained from increasing.

According to the configuration described above, therefore, while the space by the platen 43 may be used efficiently, the dimension of the inkjet printer 1 in the vertical direction may be restrained from increasing.

According to the configuration described above, the waste liquid tank 60 is located at the position below the scanner 121. Therefore, a width, or a dimension of the inkjet printer 1 in the widthwise direction, may be restrained from increasing.

While the invention has been described in conjunction with the example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

### First Modified Example

For example, the waste liquid tank 60 may not necessarily be located entirely below the flushing unit 70.

A second modified example, in which the positional relation between the waste liquid tank 60 and the flushing unit 70 is modified, will be described below with reference to FIG. 7. FIG. 7 illustrates modified arrangement of the waste liquid guide 71 and the waste liquid tank 60.

As shown in FIG. 7, the waste liquid guide 71 in the flushing unit 70 may be located at a position, in which the waste liquid guide 71 at least partly overlaps the waste liquid tank 60 in the direction intersecting orthogonally with the nozzle surface 421, i.e., in the vertical direction. In particular, a lower end portion of the waste liquid guide 71 may be located on an inner side from the side face of the waste liquid case 61. FIG. 7 shows an exemplary arrangement, in which the flushing unit 70 is shifted rightward by a length L. In FIG. 7, the waste liquid guide 71 may include two (2) pieces of waste liquid guide 71, and the lower end portion of one of the pieces of waste liquid guide 71 on the right is located on the inner side of the waste liquid case 61.

According to the second modified example, the waste liquid guide 71 may be arranged at the position to at least partly overlap the waste liquid tank 60 in the direction intersecting orthogonally with the nozzle surface 421. For example, if the inks are allowed to drop directly from the nozzle surface 421 to the waste liquid tank 60 without flowing down on the waste liquid guide 71, a distance for the inks to fall may be longer than the arrangement, in which the waste liquid guide 71 at least partly intervenes between the nozzle surface 421 and the waste liquid tank 60, and the droplets of the inks may vaporize to scatter in mist more easily. In this regard, according to the arrangement of the second modified example, the inks may fall in the waste liquid tank 60 from the end of the waste liquid guide 71. Therefore, the distance for the droplets of the inks to fall may be shortened, and the inks may be restrained from vaporizing or scattering in mist.

### Second Modified Example

A second modified example will be described below with reference to FIGS. 8A-8B. FIG. 8A illustrates a modified example of the waste liquid tank 60 mounted in the main housing 11. FIG. 8B illustrates the waste liquid tank 60 being drawn outward from the main housing 11.

As shown in FIGS. 8A-8B, the waste liquid tank 60 may have a contact portion 64, which may contact the lower end portion of the waste liquid guide 71, on the edge facing the nozzle surface 421.

In particular, the contact portion 64 may be located on an upper edge 611 of one of the side faces of the waste liquid case 61 located on the inner side in the mounting/demounting direction of the waste liquid tank 60. The contact portion 64 may consist of, for example, unwoven fabric, sponge, or cotton that may absorb the inks.

According to the second modified example, the waste liquid case 61 has the contact portion 64, which may contact the lower end portion of the waste liquid guide 71, on the upper edge of the waste liquid case 61. Therefore, for example, as shown in FIG. 8B, when the waste liquid tank 60 is demounted from the main housing 11, the waste liquid remaining on the lower end portion of the waste liquid guide 71 may be collected by the contact portion 64. Thus, after the waste liquid tank 60 is demounted from the main housing 11, the inks on the waste liquid guide 71 may be restrained from dripping to stain inside the main housing 11.

### Third Modified Example

A third modified example, in which the compartment 152 is modified, will be described with reference to FIGS. 9A-9B. FIG. 9A illustrates the waste liquid tank 60 mounted in the main housing. FIG. 9B illustrates the waste liquid tank 60 being drawn outward from the main housing 11.

The compartment 152 in the third modified example has an inclination-angle changeable assembly, which may change inclination angle of the waste liquid guide 71 when the waste liquid tank 60 is being mounted in or demounted from the main housing 11, on a wall 1521. The wall 1521 is a wall of the compartment 152 facing one of the side faces of the waste liquid tank 60 on the inner side in the mounting/demounting direction. In particular, the compartment 152 has an urging member 153 and a restrictive protrusion 154, which form the inclination-angle changeable assembly, as shown in FIGS. 9A-9B, on the wall 1521. The flushing unit 70 in the third modified example is fixed to the wall 1521 of the main housing 11 through the inclination-angle changeable assembly.

The urging member 153 urges the guide retainer frame 72 from one side toward the other side in the mounting/demounting direction of the waste liquid tank 60. The urging member 153 may consist of a spring with elasticity. In particular, the urging member 153 may urge the guide retainer frame 72 from right to left in the mounting/demounting direction. The urging member 153 is connected to a receiver wall 723, which will be described below. In other words, the urging member 153 is located between the wall 1521 and the receiver wall 723.

The restrictive protrusion 154 protrudes from the wall 1521 leftward, i.e., in an outward direction from the inner side of the main housing 11. The restrictive protrusion 154 may collide with a pivot-restrictive portion 722, which will be described below, to restrict the guide retainer frame 72 from pivoting further.

The guide retainer frame 72 is pivotable with respect to the main housing 11 on an axis, which extends in a direction intersecting orthogonally with the mounting/demounting direction. The guide retainer frame 72 has, as shown in FIGS. 9A-9B, a shaft 721, the pivot-restrictive portion 722, and the receiver wall 723.

The shaft 721 is located on a rightward side of the guide retainer frame 72, i.e., on the inner side in the main housing 11. Through the shaft 721, the guide retainer frame 72 is supported pivotably by the main housing 11 to pivot with respect to the main housing 11.

The pivot-restrictive portion 722 protrudes upward from one end of the guide retainer frame 72 on the inner side in the main housing 11. In particular, the pivot-restrictive portion 722 is formed to incline to be higher toward the left from the one end of the guide retainer frame 72 on the inner side of the main housing 11.

The receiver wall 723 is located on an opposite side to the pivot-restrictive portion 722 across the guide retainer frame 72. The receiver wall 723 protrudes downward from the guide retainer frame 72. The receiver wall 723 may, in an arrangement where the waste liquid tank 60 is accommodated in the compartment 152, contact one of the side surfaces, e.g., the rightward surface, that form the waste liquid case 61 on the inner side in the main housing 11 in the mounting/demounting direction of the waste liquid tank 60.

According to the fourth modified example, for example, as shown in FIG. 9A, when the waste liquid tank 60 is pushed in the compartment 152, the waste liquid tank 60 may contact the receiver wall 723. As the waste liquid tank 60 is pushed further inward in the main housing 11, the guide retainer frame 72 may pivot counterclockwise to be set in a position where a lower face of the guide retainer frame 72 and a bottom face of the waste liquid tank 60 are parallel.

On the other hand, when the waste liquid tank 60 is drawn outward from the position where the waste liquid tank 60 is set in the compartment 152, as shown in FIG. 9B, the waste liquid tank 60 separates from the receiver wall 723. As the waste liquid tank 60 separates from the receiver wall 723, the guide retainer frame 72 may be moved by the urging force of the urging member 153 to pivot clockwise to a position where the pivot-restrictive portion 722 contacts the restrictive protrusion 154. As the guide retainer frame 72 pivots clockwise, the waste liquid guide 71 fixed to the guide retainer frame 72 may move to a position where the slant surface 710 is substantially parallel to the bottom face of the waste liquid tank 60. In this posture of the waste liquid guide 71, the inclination angle of the waste liquid guide 71 may be changed so that the inks on the waste liquid guide 71 may be prevented from dripping down from the waste liquid guide 71 while the waste liquid tank 60 is absent from the compartment 152.

### Fourth Modified Example

A fourth modified example will be described with reference to FIG. 10. FIG. 10 illustrates a modified example of the compartment 152, modified from the compartment 152 shown in FIG. 3. According to the fourth modified example, the compartment 152 that forms a part of the main housing 11 is connected with the maintenance unit 8 through the tube 82. As shown in FIG. 10, the compartment 152 has a port 1552. The port 1552 is a part of the compartment 152, to which the tube 82 is connected. The tube 82 is connected to the maintenance unit 8 at a first end being one end thereof and to the main housing 11 at a second end being the other end thereof. The second end of the tube 82 is detachably connected to the compartment 152 in the main housing 11.

In particular, the port 1522 is located at a position where, in the condition where the waste liquid tank 60 is mounted in the compartment 152 of the main housing 11, the waste liquid ejected from the second end of the tube 82 is receivable in the waste liquid tank 60. For example, the port 1522 may be formed in the wall 1521, which faces one of the side faces of the waste liquid tank 60 facing inward in the mounting/demounting direction. The port 1522 has a communication hole, through which the inside and the outside of the wall 1521 communicate, and the tube 82 is detachably connected to the port 1522 in an arrangement such that the second end is located inside the waste liquid case 61.

Meanwhile, the port 1522 may not necessarily be located in the wall 1521 but may be located in, for example, a frontward wall or a leftward wall of the compartment 152, as long as the port 1522 is located in one of the walls forming the compartment 152.

According to the fourth modified example, the compartment 152 forming a part of the main housing 11 has the port 1522, to which the second end of the tube 82 is connected. Moreover, the port 1522 is located at the position, where the waste liquid may be ejected from the second end of the tube 82 to be stored in the waste liquid tank 60, in the condition where the waste liquid tank 60 is mounted in the compartment 152 of the main housing 11. In this arrangement, while the tube 82 is not directly connected with the waste liquid tank 60, the waste liquid tank 60 may accept and store the waste liquid.

Moreover, the tube 82 is detachably connected to the wall 1521 in the arrangement where the second end of the tube 82 is located inside the waste liquid case 61. Therefore, the inlet to the waste liquid tank 60 to accept the waste liquid ejected from the flushing unit 70 and the inlet to the waste liquid tank 60 to accept the waste liquid ejected from the tube 82 may be unified. Accordingly, the form of the waste liquid tank 60 may be simplified.

### Fifth Modified Example

A fifth modified example will be described with reference to FIGS. 11-12. FIGS. 11-12 illustrate a modified example of the flushing unit 70. As shown in FIG. 11, the flushing unit 70 in the fifth modified example has a port 725.

The port 725 is formed in the guide retainer frame 72. In other words, the tube 82 is detachably connected to the guide retainer frame 72 through the port 725. In this arrangement of the flushing unit 70, optionally, for example, as shown in FIG. 11, a waste liquid guide 711 to guide the waste liquid produced in the maintenance process from the maintenance unit 8 may be provided, separately from the waste liquid guide 71 that guides the waste liquid produced in the flushing process to the waste liquid tank 60.

According to the fifth modified example, the tube 82 may be detachably connected to the guide retainer frame 72. In this arrangement, while the tube 82 is not connected with the waste liquid tank 60, the waste liquid tank 60 may accept and store the waste liquid ejected from the tube 82. In other words, the paths to transport the waste liquid may be consolidated in the flushing unit 70. Therefore, the form of the waste liquid tank 60 may be simplified, and moreover, a number of parts of the inkjet printer 1 to be manufactured may be reduced, and the manufacturing cost may be lowered. Furthermore, the waste liquid guide 711 may be exchanged with a new waste liquid guide 711 together with the tube 82 when the tube 82 is exchanged with a new tube 82. Thus, efficiency in exchanging works may be improved.

Optionally, the flushing unit 70 may have the tube 82 to be connected to the guide retainer frame 72 in an arrangement such that the second end of the tube 82 contacts a surface of the waste liquid guide 71 on a side opposite to the slant surface 710 that faces toward the nozzle surface 421, as shown in FIG. 12. In this arrangement, the waste liquid guide 711 shown in FIG. 11 may be omitted.

According to the arrangement of the fifth modified example, the tube 82 may be located to contact the surface of the waste liquid guide 71 on the side opposite to the surface facing toward the nozzle surface 421, i.e., the lower surface of the waste liquid guide 71. In this arrangement, even when, for example, the waste liquid produced in the maintenance process may bubble at the second end of the tube 82 and scatter in mist, a scattering range of the mist may be limited by the lower surface of the waste liquid guide 71.

### Sixth Modified Example

Earlier, the first modified example described the tube 82 arranged at the position higher than the conveyer path R1. However, the arrangement of the tube 82 may not necessarily be limited to the position above the conveyer path R1, but the tube 82 may be arranged at positions, for example, as indicated by dots A-D shown in FIG. 13. FIG. 13 is a cross-sectional view of the inkjet printer 1 illustrating the optional positions A-D of the tube 82.

For example, the tube 82 may be located to be lower than the platen 43, as indicated by the dot A in FIG. 13. In this arrangement, while the waste liquid tank 60 is located opposite to the maintenance unit 8 across the conveyer path R1, the length of the tube 82 may still be reduced. Moreover, without the tube 82 over the conveyer path R1, when the sheet P j ams in the area between the platen 43 and the recorder 4, the user may access the sheet P from above and remove the jammed sheet P easily.

For another example, the tube 82 may be located frontward with respect to the feeder arm 31, as indicated by the dot B in FIG. 13. In this arrangement, when the feeder tray 21 is drawn outside from the main housing 11, the tube 82 may be visible to the user from the outside of the main housing 11. Therefore, the tube 82 may be exchanged with a new tube 82 while the user visually recognizes the position of the tube 82.

For another example, the tube 82 may be located to be lower than the feeder tray 21, as indicated by the dot C in FIG. 13. In particular, the tube 82 may be drawn to an area underneath a bottom face 11b of the main housing 11. Optionally, the tube 82 may be fixed to the bottom face 11b with a fixture formation (not shown). Moreover, in this arrangement, the main housing 11 may preferably have legs 11d extended downward from the bottom face 11b. In this arrangement of the tube 82 located at the position C, the user may access the tube 82 in the area on the lower side of the bottom face 11b delimited by the bottom face 11b and the legs 11d without removing the feeder tray 21 from the main housing 11. Therefore, the tube 82 may be exchanged with a new tube 82 while the user visually recognizes the tube 82.

For another example, the tube 82 may be located rearward with respect to the feeder tray 21, as indicated by the dot D in FIG. 13. In this arrangement, it may be preferable that the main housing 11 has a rear cover 11c, which is continuous from an upper face 11a and the bottom face 11b, on the rear side of the inkjet printer 1. The rear cover 11c may be openable/closable with respect to the remainder of the main housing 11. In this arrangement of the tube 82 at the position D, the user may open the rear cover 11c to access the tube 82 arranged inside the main housing 11 easily and exchange the tube 82 with another tube 82 while visually recognizing the tube 82.

### Second Embodiment

A second embodiment of the present disclosure will be described below. In the following paragraphs, items that are substantially identical to those described above will be referred to by the same reference signs, and description of those items is herein omitted.

An inkjet printer 200 according to the second embodiment of the present disclosure will be described with reference to FIGS. 14-15. FIG. 14 is a cross-sectional view to illustrate an inner structure of the inkjet printer 200. FIG. 15 is a cross-sectional view of the inkjet printer 200 viewed from front.

As shown in FIG. 14, the inkjet printer 200 according to the second embodiment differs from the inkjet printer 1 in the first embodiment in that the inkjet printer 200 has a conveyer path R2 additionally to the conveyer path R1. Moreover, the conveyer 5 has conveyer rollers 54, 56 and spur rollers 55, 57 for conveying the sheets P in the conveyer path R2 at positions upstream from the ejection roller 52 in the conveying direction. The conveyer rollers 54, 56 may be driven by the conveyer motor (not shown).

The conveyer path R2 is a duplex conveyer path for conveying the sheet P in a second conveying direction D2, which is a direction opposite to a first conveying direction D1. The first conveying direction D1 is the conveying direction, in which the sheet P fed to a convey-start position V may be conveyed in the conveyer path R1. The conveyer path R2 is a path delimited by guide members 65, 66, 67, a conveyer roller 68, and a pinch roller 69. The conveyer path R2 branches off from the conveyer path R1 at a branch position Y, which is located upstream from the conveyer roller 56, and merges with the conveyer path R1 at a merge position W, which is located upstream from the recorder 4, in the first conveying direction D1.

When the sheet P conveyed in the first conveying direction D1 in the conveyer path R1 reaches a position, at which a rear edge of the sheet P passes through a first flap 46, the conveyer roller 56 and the spur roller 57 may rotate reversely. Thereby, the sheet P nipped by the conveyer roller 56 and the spur roller 57 may be conveyed along a lower surface of the first flap 46 and enter the conveyer path R2.

The first flap 46 is located between the conveyer roller 54 and the conveyer roller 56 in the conveyer path R1. The first flap 46 is located in the vicinity to the branch position Y and faces the guide member 44. The first flap 46 is supported by the platen 43 and is pivotable between a first posture, as indicated by solid lines in FIG. 14, and a second posture, as indicated by broken lines in FIG. 14. The first flap 46 in the first posture contacts the guide member 44 and closes the conveyer path R1. On the other hand, the first flap 46 in the second posture is located to be lower than the first flap 46 in the first posture and is separated from the guide member 44 to allow the sheet S to be conveyed in the first conveying direction D1 to pass over the first flap 46. The first flap 46 is urged upward by a coil spring 47. The coil spring 47 is connected to the first flap 46 at one end to the platen 43 at the other end thereof. The first flap 46 urged by the coil spring 47 may be placed in the first posture, and when the first flap 46 is in the first posture, a front end of the first flap 46 may contact the guide member 44.

As shown in FIG. 14, at the merge position W between the conveyer path R1 and the conveyer path R2, a second flap 48 is located. The second flap 48 is pivotable between a first posture, as indicated in solid lines in FIG. 14, and a second posture, as indicated in broken lines in FIG. 14. When the second flap 48 is in the first posture, the second flap 48 and the guide member 33a form a part of the conveyer path R2. When the second flap 48 is in the second posture, the second flap 48 and the guide member 33b form a part of the conveyer path R1.

<Arrangement of Waste Liquid Tank 60>

The waste liquid tank 60 in the second embodiment and the conveyer path R2 are arrayed side by side in the horizontal direction. In particular, as shown in FIG. 15, the maintenance unit 8, the conveyer path R2, and the waste liquid tank 60 are arrayed side by side from right to left in this recited order. More specifically, as shown in FIG. 14, the waste liquid tank 60 is located to at least partly overlap the conveyer path R2 in a view along a direction, which is parallel to the nozzle surface 421 and is a direction of width of the sheet P intersecting orthogonally with the first conveying direction D1, i.e., the widthwise direction.

Meanwhile, the conveyer path R2 and the waste liquid tank 60 may not necessarily be align at the same height in the vertical direction as long as the conveyer path R2 and the waste liquid tank 60 are arrayed horizontally side by side. In other words, for example, the maintenance unit 8 may be located to be higher than the conveyer path R2 while the waste liquid tank 60 may be located to be lower than the conveyer path R2.

According to the arrangement in the second embodiment, in the inkjet printer 200 having the conveyer path R2, i.e., the duplex conveyer path, the space on the right and the left of the conveyer path R2 may be used efficiently. Moreover, the height of the inkjet printer 200 may be restrained from increasing.

### Third Embodiment

An inkjet printer 300 according to a third embodiment of the present disclosure will be described with reference to FIG. 16. FIG. 16 is a cross-sectional view of the inkjet printer 300 viewed from an upper side. As shown in FIG. 16, the inkjet printer 300 differs from the inkjet printer 1 and the inkjet printer 200 by the position of the waste liquid tank 60. Moreover, an arrangement of the tube 82 connecting the waste liquid tank 60 and the maintenance unit 8 of the inkjet printer 300 is different from that in the inkjet printer 1 and the inkjet printer 200.

In particular, the tube 82 is located at a position to at least partly overlap the conveyer path R1 in the direction intersecting orthogonally with the nozzle surface 421 of the recording head 41 mounted on the carriage 40, i.e., in the vertical direction. According to the third embodiment, the tube 82 may be drawn in an area above the conveyer path R1 to overlap the conveyer path R1. In the meantime, the tube 82 may not necessarily be drawn in the area above the conveyer path R1 but may optionally be drawn in an area below the conveyer path R1. Moreover, the tube 82 may be drawn to meander in the area above or below the conveyer path R1.

According to the arrangement of the third embodiment, the tube 82 is arranged to at least partly overlap the conveyer path R1 in the direction intersecting orthogonally with the nozzle surface 421, i.e., the vertical direction. In this arrangement, the tube 82 may be lengthened to be longer than the tube 82 in the inkjet printer 1 or the inkjet printer 200. Therefore, the capacity to store the waste liquid in the inkjet printer 300 may be increased by the lengthened amount of the tube 82.

What is claimed is:

1. A liquid discharging apparatus, comprising:
a sheet conveyer path;
a liquid discharging head including nozzles for discharging liquid;
a maintenance unit configured to remove the liquid from discharging head;
a waste liquid tank demountably mounted in a housing of the liquid discharging apparatus, the waste liquid tank being configured to store the liquid received from the maintenance unit; and
a waste liquid flow path for transporting the liquid from the maintenance unit to the waste liquid tank,
wherein the waste liquid tank is located opposite to the maintenance unit across the sheet conveyer path in a horizontal direction, the horizontal direction being parallel to a nozzle surface of the liquid discharging head.

2. The liquid discharging apparatus according to claim 1, wherein the waste liquid tank is located at a position where the waste liquid tank at least partly overlaps the nozzle surface of the liquid discharging head in a direction intersecting orthogonally with the nozzle surface.

3. The liquid discharging apparatus according to claim 1, further comprising a flushing unit, the flushing unit having a waste liquid guide, the waste liquid guide being configured to guide the liquid removed from the liquid discharging head in a flushing process to the waste liquid tank,
wherein the waste liquid guide is located at a position, at which the waste liquid guide at least partly overlaps the waste liquid tank in a direction intersecting orthogonally with the nozzle surface of the liquid discharging head.

4. The liquid discharging apparatus according to claim 3, further comprising a contact portion, the contact portion being located on an edge of the waste liquid tank facing the nozzle surface of the liquid discharging head, the contact portion being configured to contact a lower end portion of the waste liquid guide.

5. The liquid discharging apparatus according to claim 3, further comprising an inclination angle changeable assembly located in the housing, the inclination angle changeable assembly being configured to change an inclination angle of the waste liquid guide in a condition where the waste liquid tank is being mounted in and demounted from the housing.

6. The liquid discharging apparatus according to claim 3, further comprising a retainer retaining the waste liquid guide,
wherein the waste liquid flow path is connected to the retainer.

7. The liquid discharging apparatus according to claim 6, wherein an end of the waste liquid flow path contacts a surface of the waste liquid guide on a side opposite to a surface facing toward the nozzle surface.

8. The liquid discharging apparatus according to claim 1, wherein the waste liquid flow path extending from the maintenance unit to the waste liquid tank traverses the sheet conveyer path.

9. The liquid discharging apparatus according to claim 1, wherein
the waste liquid flow path is connected to the maintenance unit at a first end thereof,
the housing has a port, to which a second end of the waste liquid flow path opposite to the first end is connectable, and
the port is located at a position, at which the waste liquid ejected from the second end of the waste liquid flow path connected to the port is receivable in the waste liquid tank mounted in the housing.

10. The liquid discharging apparatus according to claim 1, further comprising a sheet storage for storing sheets,
wherein the waste liquid tank and the sheet storage are located at positions to at least partly overlap each other in a view along a widthwise direction of the housing, the widthwise direction being parallel to the nozzle surface of the liquid discharging head and intersecting orthogonally with a conveying direction to convey the sheets in the sheet conveyer path.

11. The liquid discharging apparatus according to claim 1, further comprising a duplex conveyer path, wherein
the sheet conveyer path is a path for conveying a sheet in one direction, and the duplex conveyer path is a path for conveying the sheet in the other direction opposite to the one direction, and
the waste liquid tank and the duplex conveyer path are located at positions to at least partly overlap each other in a view along a widthwise direction of the housing, the widthwise direction being parallel to the nozzle surface of the liquid discharging head and intersecting orthogonally with the one and the other directions to convey the sheet.

12. The liquid discharging apparatus according to claim 1, further comprising a platen configured to support a sheet,
wherein the waste liquid tank and the platen are located at positions to at least partly overlap each other in a view along a widthwise direction of the housing, the widthwise direction being parallel to the nozzle surface of the liquid discharging head and intersecting orthogonally with a conveying direction to convey the sheet in the sheet conveyer path.

13. The liquid discharging apparatus according to claim 1, further comprising a reader configured to read an object,
wherein the waste liquid tank is located to be lower than the reader.

14. The liquid discharging apparatus according to claim 1, wherein the waste liquid tank is located at a position to at least partly overlap the sheet conveyer path in a view along a direction intersecting orthogonally with the nozzle surface of the liquid discharging head.

15. The liquid discharging apparatus according to claim 1, further comprising an operation panel including an operation device, the operation panel being arranged on an outer face of the housing,
wherein the waste liquid flow path is located inside the housing at a position rearward with respect to the operation panel.

16. The liquid discharging apparatus according to claim 1, further comprising a reader configured to scan an object,
wherein the waste liquid flow path is located to be lower than the reader.

17. The liquid discharging apparatus according to claim 1, wherein the waste liquid flow path is located frontward with respect to the liquid discharging head.

18. The liquid discharging apparatus according to claim 1, wherein the waste liquid flow path is located rearward with respect to the liquid discharging head.

19. The liquid discharging apparatus according to claim 1, wherein the waste liquid flow path is located to be higher than sheet conveyer path.

20. The liquid discharging apparatus according to claim 1, further comprising a platen configured to support a sheet,
wherein the waste liquid flow path is located to be lower than the platen.

21. The liquid discharging apparatus according to claim 1, further comprising:
a sheet storage for storing sheets, the sheet storage being detachably attached to the housing; and
a feeder arm having a feeder roller, the feeder roller being configured to feed the sheets to the sheet conveyer path,
wherein the waste liquid flow path is located frontward with respect to the feeder arm.

22. The liquid discharging apparatus according to claim 1, further comprising a sheet storage for storing sheets,
wherein the waste liquid flow path is located to be lower than the sheet storage.

23. The liquid discharging apparatus according to claim 1, further comprising a sheet storage for storing sheets,
wherein the waste liquid flow path is located rearward with respect to the sheet storage.

24. A liquid discharging apparatus, comprising:
a sheet conveyer path;
a liquid discharging head including nozzles for discharging liquid;
a maintenance unit configured to remove the liquid from discharging head;
a waste liquid tank demountably mounted in a housing of the liquid discharging apparatus, the waste liquid tank being configured to store the liquid received from the maintenance unit; and
a waste liquid flow path for transporting the liquid from the maintenance unit to the waste liquid tank,
wherein the waste liquid flow path is located to at least partly overlap the sheet conveyer path in a direction intersecting orthogonally with a nozzle surface of the liquid discharging head.
